(19) United States
(12) Patent Application Publication
(10) Pub. No.: US 2025/0133582 A1
(43) Pub. Date: Apr. 24, 2025

(54) TRANSMISSION METHOD, DEVICE, AND READABLE STORAGE MEDIUM

(71) Applicant: VIVO MOBILE COMMUNICATION CO., LTD., Dongguan (CN)

(72) Inventors: Lei JIANG, Dongguan (CN); Huan WANG, Dongguan (CN); Zichao JI, Dongguan (CN)

(73) Assignee: VIVO MOBILE COMMUNICATION CO., LTD., Dongguan (CN)

(21) Appl. No.: 18/988,757

(22) Filed: Dec. 19, 2024

Related U.S. Application Data
(63) Continuation of application No. PCT/CN2023/100176, filed on Jun. 14, 2023.

(30) Foreign Application Priority Data
Jun. 21, 2022 (CN) 202210707515.X

(51) Int. Cl. H04W 72/40; H04W 28/26; H04W 72/0446; H04W 72/25; H04W 92/18

(52) U.S. Cl. CPC H04W 72/40; H04W 28/26; H04W 72/0446; H04W 72/25; H04W 92/18

(57) ABSTRACT

This application provides a transmission method, a device, and a readable storage medium. The method includes: receiving, by a first terminal by detecting a physical sidelink control channel (PSCCH) in a candidate position of the PSCCH in a mini-slot, sidelink (SL) data sent by a second terminal. The length of the mini-slot is less than one slot, and one slot includes one or more starting positions of the mini-slot.

### CROSS-REFERENCE TO RELATED APPLICATIONS

This application is a continuation of International Application No. PCT/CN 2023/100176, filed on Jun. 14, 2023, which claims priority to Chinese Patent Application No. 202210707515.X, filed on Jun. 21, 2022. The entire contents of each of the above-referenced applications are expressly incorporated herein by reference.

### TECHNICAL FIELD

This application pertains to the field of communication technologies, and specifically, to a transmission method, a device, and a readable storage medium.

### BACKGROUND

According to an existing sidelink (SL) channel structure, each SL transmission (such as a physical sidelink control channel (PSCCH) or a physical sidelink shared channel (PSSCH)) uses a fixed length (such as a slot (slot)) as a minimum transmission unit, and the transmission is started from a fixed (periodic) position (such as a starting position of a slot). However, in an unlicensed band, under a listen before talk (LBT) channel access mechanism, a time when a channel is detected as idle is uncertain. If the time when the channel is idle is not a starting position of a slot, an SL transmission cannot be immediately performed, and the transmission needs to be delayed and cannot be performed until a starting position of a next slot. This not only reduces resource utilization, but also may make the channel preempted by another device in the unlicensed band during the delay. Therefore, performance of the existing slot-based SL transmission in the unlicensed band is poor.

### SUMMARY

Embodiments of this application provide a transmission method, a device, and a readable storage medium.

According to a first aspect, a transmission method is provided and includes:
receiving, by a first terminal by detecting a physical sidelink control channel PSCCH in a candidate position of the PSCCH in a mini-slot, SL data sent by a second terminal, where
a length of the mini-slot is less than one slot, and one slot includes one or more starting positions of the mini-slot.

According to a second aspect, a transmission method is provided and includes:
sending, by a second terminal, SL data to a first terminal by using a mini-slot, where
a length of the mini-slot is less than one slot, one slot includes one or more starting positions of the mini-slot, the mini-slot includes a candidate position of a PSCCH, and the candidate position of the PSCCH is used to transmit the PSCCH.

According to a third aspect, a transmission apparatus is provided and includes:
a first receiving module, configured to receive, by detecting a PSCCH in a candidate position of the PSCCH in a mini-slot, SL data sent by a second terminal, where
a length of the mini-slot is less than one slot, and one slot includes one or more starting positions of the mini-slot.

According to a fourth aspect, a transmission apparatus is provided and includes:
a first sending module, configured to send SL data to a first terminal by using a mini-slot, where
a length of the mini-slot is less than one slot, one slot includes one or more starting positions of the mini-slot, the mini-slot includes a candidate position of a PSCCH, and the candidate position of the PSCCH is used to transmit the PSCCH.

According to a fifth aspect, a terminal is provided. The terminal includes a processor and a memory. The memory has stored thereon a program or instructions capable of running on the processor. When the program or instructions are executed by the processor, the steps of the method according to the first aspect or the second aspect are implemented.

According to a sixth aspect, a terminal is provided and includes a processor and a communication interface. The communication interface is configured to: receive, by a first terminal by detecting a physical sidelink control channel PSCCH in a candidate position of the PSCCH in a mini-slot, SL data sent by a second terminal, where a length of the mini-slot is less than one slot, and one slot includes one or more starting positions of the mini-slot; or
send, by a second terminal, SL data to a first terminal by using a mini-slot, where a length of the mini-slot is less than one slot, one slot includes one or more starting positions of the mini-slot, the mini-slot includes a candidate position of a PSCCH, and the candidate position of the PSCCH is used to transmit the PSCCH.

According to a seventh aspect, a readable storage medium is provided. The readable storage medium has stored thereon a program or instructions. When the program or instructions are executed by a processor, the steps of the method according to the first aspect are implemented, or the steps of the method according to the second aspect are implemented.

According to an eighth aspect, a chip is provided. The chip includes a processor and a communication interface. The communication interface is coupled to the processor. The processor is configured to run a program or instructions to implement the steps of the method according to the first aspect or implement the steps of the method according to the second aspect.

According to a ninth aspect, a computer program or program product is provided. The computer program or program product is stored in a storage medium. The computer program or program product is executed by at least one processor to implement the steps of the method according to the first aspect or implement the steps of the method according to the second aspect.

In the embodiments of this application, by detecting the candidate position of the PSCCH in a mini-slot-based SL transmission, mini-slot-based SL data reception is implemented, and resource utilization in an unlicensed band is improved.

### BRIEF DESCRIPTION OF DRAWINGS

FIG. 1 is a block diagram of a wireless communication system according to an embodiment of this application;

FIG. 2 is an existing SL channel structure;

FIG. 3 is a first schematic flowchart of a transmission method according to an embodiment of this application;

FIG. 4 is a second schematic flowchart of a transmission method according to an embodiment of this application;

FIG. 5 is a schematic diagram of an application example according to an embodiment of this application;

FIG. 6 is a first schematic diagram of a structure of a transmission apparatus according to an embodiment of this application;

FIG. 7 is a second schematic diagram of a structure of a transmission apparatus according to an embodiment of this application;

FIG. 8 is a schematic diagram of a structure of a communication device according to an embodiment of this application; and

FIG. 9 is a schematic diagram of a structure of a terminal according to an embodiment of this application.

### DETAILED DESCRIPTION

The following clearly describes the technical solutions in the embodiments of this application with reference to the accompanying drawings in the embodiments of this application. Apparently, the described embodiments are only some rather than all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specified order or sequence. It should be understood that the terms used in this way are interchangeable in appropriate circumstances, so that the embodiments of this application can be implemented in other orders than the order illustrated or described herein. In addition, objects distinguished by “first” and “second” usually fall within one class, and a quantity of objects is not limited. For example, there may be one or more first objects. In addition, the term “and/or” in the specification and claims indicates at least one of connected objects, and the character “/” generally represents an “or” relationship between associated objects.

It should be noted that technologies described in the embodiments of this application are not limited to a Long Term Evolution (LTE)/LTE-Advanced (LTE-A) system, and can also be used in other wireless communication systems, such as Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), and other systems. The terms “system” and “network” in the embodiments of this application are usually used interchangeably. The described technologies may be used for the foregoing systems and radio technologies, and may also be used for other systems and radio technologies. However, in the following descriptions, the new radio (NR) system is described for an illustrative purpose, and NR terms are used in most of the following descriptions. These technologies may also be applied to other applications than an NR system application, for example, a 6th Generation (6G) communication system.

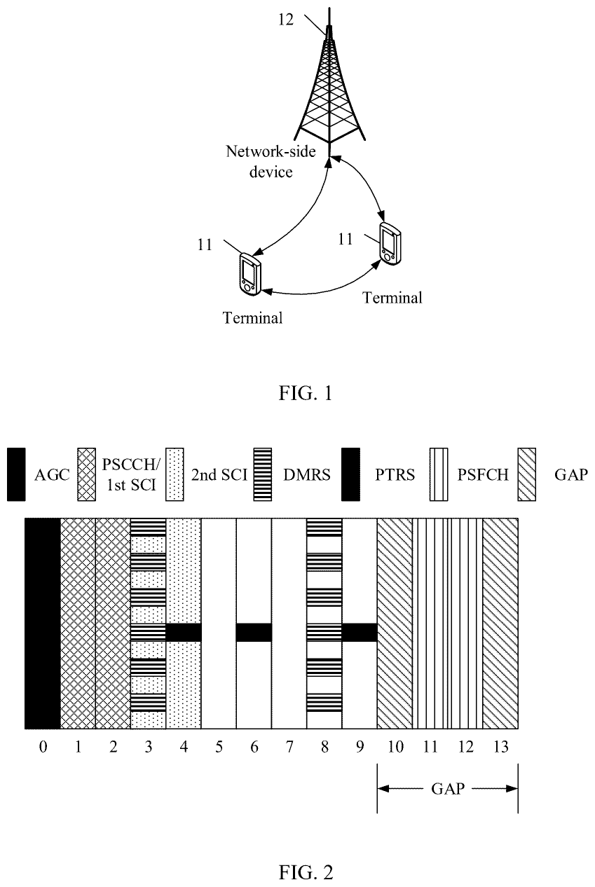

FIG. 1 is a block diagram of a wireless communication system to which an embodiment of this application may be applied. The wireless communication system includes a terminal 11 and a network-side device 12. The terminal 11 may be a terminal-side device such as a mobile phone, a tablet personal computer, a laptop computer or a notebook computer, a Personal Digital Assistant (PDA), a palmtop computer, a netbook, an ultra-mobile personal computer (UMPC), a Mobile Internet Device (MID), an augmented reality (AR) or virtual reality (VR) device, a robot, a wearable device, vehicle user equipment (VUE), pedestrian user equipment (PUE), a smart home (a home device having a wireless communication function, such as a refrigerator, a television, a washing machine, or furniture), a game console, a personal computer (PC), a teller machine, or a self-service machine. The wearable device includes a smartwatch, a smart band, a smart headphone, smart glasses, smart jewelry (a smart bracelet, a smart wrist chain, a smart ring, a smart necklace, a smart anklet, a smart ankle chain, or the like), a smart wristband, smart clothing, or the like. It should be noted that a specific type of the terminal 11 is not limited in the embodiments of this application. The network-side device 12 may include an access network device or a core network device. The access network device may also be referred to as a radio access network device, a radio access network (RAN), a radio access network function, or a radio access network element. The access network device may include a base station, a wireless local area network (WLAN) access point, a Wireless Fidelity (Wi-Fi) node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmission Reception Point (TRP), or another appropriate term in the art. As long as the same technical effect is achieved, the base station is not limited to specific technical terms. It should be noted that in the embodiments of this application, only a base station in an NR system is used as an example for description, but a specific type of the base station is not limited.

For better understanding the technical solutions of this application, the following content is first described.

### Unlicensed Band

In a future communication system, an unlicensed band may be used to supplement a licensed band, to help an operator expand services. To keep consistency with NR deployment and maximize NR-based unlicensed access as much as possible, the unlicensed band can work in 5 GHz, 37 GHz, and 60 GHz bands. A large bandwidth (80 MHz or 100 MHz) of the unlicensed band can reduce implementation complexity of a base station and UE. Because the unlicensed band is shared by a plurality of radio access technologies (RATs), such as Wi-Fi, radar, and LTE license-assisted access (LAA), in some countries or regions, use of the unlicensed band needs to comply with regulations, such as listen before talk (LBT), a maximum channel occupancy time (MCOT), and other regulations, to ensure that all devices can use the resource fairly. When a transmission node needs to send information, the transmission node needs to perform LBT first and perform energy detection (ED) on nearby nodes. When detected power is lower than a threshold, a channel is considered as idle and the transmission node can send the information. Otherwise, the channel is considered as busy and the transmission node cannot send the information. The transmission node may be a base station, UE, a Wi-Fi access point (AP), or the like. After the transmission node starts a transmission, a channel occupancy time (COT) cannot exceed the MCOT. In addition, according to an occupied channel bandwidth (OCB) regulation, in the unlicensed band, the transmission node should occupy at least 70% (60 GHz) or 80% (5 GHz) of the bandwidth of the entire band during each transmission.

Types (type) of LBT commonly used in NRU may include type 1, type 2A, type 2B, and type 2C. The NRU refers to a 5G New Radio in Unlicensed Spectrum. Type 1 LBT is a channel listening mechanism based on back-off. When the transmission node detects that the channel is busy, the transmission node backs off and continues listening until the transmission node detects that the channel is idle. Type 2C LBT means that a sending node does not perform LBT, that is, there is no LBT or an immediate transmission is performed. Type 2A LBT and type 2B LBT are one-shot LBT, that is, the node performs LBT once before the transmission. If the channel is idle, the node performs the transmission, or if the channel is busy, the node does not perform the transmission. A difference is as follows: Type 2A LBT is performed within 25 μs and is applicable during sharing of the COT if a gap between two transmissions is greater than or equal to 25 μs. Type 2B LBT is performed within 16 μs and is applicable during sharing of the COT if a gap between two transmissions is equal to 16 μs. In addition, there is type 2 LBT, applicable to LAA/eLAA/FeLAA. During sharing of the COT, if a gap between two transmissions is greater than or equal to 25 μs, an eNB and UE may use type 2 LBT. In addition, types of LBT within a frequency range 2-2 include type 1, type 2, and type 3. Type 1 is a channel listening mechanism based on back-off. Type 2 is one-shot LBT, and 5-μs LBT is performed within 8 μs. Type 3 is that no LBT is performed.

A Downlink (DL) or Uplink (UL) transmission burst is a group of transmissions sent by a base station or UE, with gaps not greater than 16 μs. For a transmission in the DL/UL transmission burst, the base station or the UE may perform the transmission directly without LBT after a gap. When a gap between transmissions is greater than 16 μs, the transmissions may be considered as a separate DL/UL transmission burst.

### Brief SL Description

A sidelink (or translated as a side link, sidelink, SL, or the like) transmission is a data transmission directly performed between terminals (User Equipment (UE)) over a physical layer. In an LTE sidelink, communication is performed based on broadcast. Although the LTE sidelink can be used to support basic security communication of vehicle to everything (vehicle to everything, V2X), the LTE sidelink is not applicable to other more advanced V2X services. A 5G NR (New Radio) system supports a more advanced sidelink transmission design, such as unicast, multicast, or groupcast, so that more comprehensive service types can be supported.

SL Physical Channel

As shown in FIG. 2, an automatic gain control (AGC) symbol is required before each SL transmission, and a gap symbol is required after each transmission. An AGC symbol is generally a repeated transmission of a next symbol, such as a PSCCH/PSSCH or a PSFCH. In the figure, there is a two-symbol PSFCH, and a first symbol is used for AGC. SL UE can start transmitting the PSCCH/PSSCH or the PSFCH only from a fixed position in a slot.

A transmission method provided in the embodiments of this application is hereinafter described in detail by using some embodiments and application scenarios thereof with reference to the accompanying drawings.

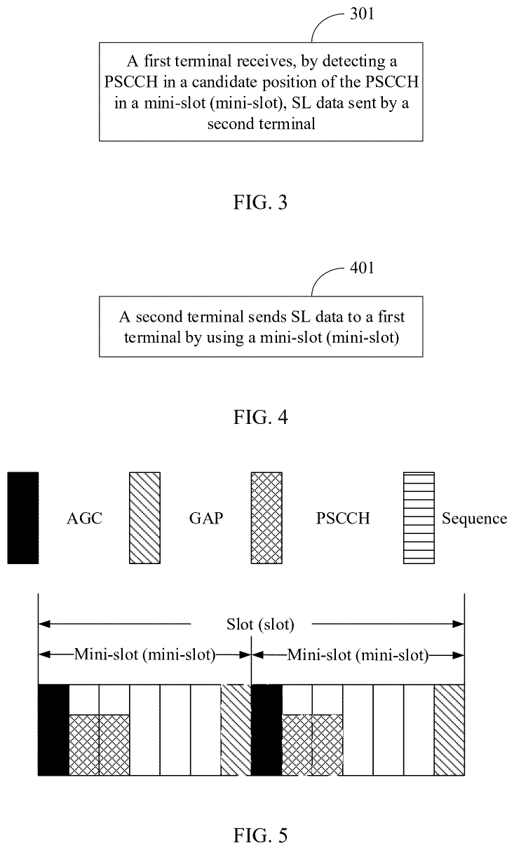

Referring to FIG. 3, an embodiment of this application provides a transmission method, including:
Step 301: A first terminal receives, by detecting a PSCCH in a candidate position of the PSCCH in a mini-slot, SL data sent by a second terminal.

A length of the mini-slot is less than one slot, and one slot includes one or more starting positions of the mini-slot. The SL data may also be referred to as a PSSCH. The mini-slot may refer to a mini-slot.

For example, the first terminal may be a terminal serving as a receive end in SL communication, and the second terminal may be a terminal serving as a transmit end in SL communication.

In this embodiment of this application, by detecting the candidate position of the PSCCH in a mini-slot-based SL transmission, mini-slot-based SL data reception is implemented, and resource utilization in an unlicensed band is improved.

For example, the terminal performs the SL transmission by using the mini-slot, and the mini-slot is a transmission unit with a length less than or equal to 13 symbols (that is, the length of the mini-slot is less than one slot). For example, the length of the mini-slot may be 5 or 7 symbols. The SL transmission may be a PSCCH, a PSSCH, or a physical sidelink feedback channel (PSFCH). One slot may include one or more starting positions of the mini-slot. The starting position and/or length of the mini-slot may be predefined or (pre)configured by a protocol, and each SL transmission in the mini-slot includes a candidate position of a PSCCH, which may also be referred to as a PSCCH transmission opportunity.

In a possible implementation, the candidate position of the PSCCH in the mini-slot meets one or more of the following:
(1) in a case that no PSCCH is transmitted in the candidate position of the PSCCH in the mini-slot, first data is transmitted in the candidate position of the PSCCH in the mini-slot, where the first data is dummy data, real data, or sidelink control information (SCI), for example, the first data may be 2nd stage SCI (2nd SCI);
(2) a time domain symbol length of the candidate position of the PSCCH in the mini-slot is one or two symbols, where when the time domain symbol length of the candidate position of the PSCCH is two symbols, the PSCCH may include an AGC symbol;
(3) a frequency domain bandwidth of the candidate position of the PSCCH in the mini-slot is two times or three times a frequency domain bandwidth of the candidate position of the PSCCH in the slot; and
(4) the candidate position of the PSCCH in the mini-slot is configured on a first subchannel, and the first subchannel meets N mod M=K, where N is a first subchannel number, M is a quantity of mini-slots in the slot, and a value range of K is an integer from 0 to M−1.

In some embodiments, one PSCCH may be allocated resources of a plurality of subchannels, that is, resources of the PSCCH are distributed on the plurality of subchannels.

The resources of the PSCCH suitable for the mini-slot-based transmission are configured based on one or more of the foregoing (1) to (4).

In a possible implementation, the method further includes:
(1) the first terminal obtains a time domain candidate position of the PSCCH and a frequency domain candidate position of the PSCCH that are configured by a network side; and
(2) the first terminal detects the PSCCH based on the time domain candidate position of the PSCCH and the frequency domain candidate position of the PSCCH.

In this embodiment, a gNB configures the time domain candidate position and frequency domain candidate position of the PSCCH in the mini-slot, and SL UE detects the PSCCH based on the configuration.

In a possible implementation, the method further includes:
(1.1) the first terminal obtains a time domain candidate position of the PSCCH;
(1.2) the first terminal determines a frequency domain candidate position of the PSCCH based on a PSCCH detection capability of the first terminal and the time domain candidate position of the PSCCH, where for example, the PSCCH detection capability of the first terminal may be prescribed by a protocol or may be configured by a network side; and
(1.3) the first terminal detects the PSCCH based on the time domain candidate position of the PSCCH and the frequency domain candidate position of the PSCCH; or
(2.1) the first terminal obtains a frequency domain candidate position of the PSCCH;
(2.2) the first terminal determines a time domain candidate position of the PSCCH based on a PSCCH detection capability of the first terminal and the frequency domain candidate position of the PSCCH, where for example, the PSCCH detection capability of the first terminal may be prescribed by a protocol or may be configured by a network side; and
(2.3) the first terminal detects the PSCCH based on the time domain candidate position of the PSCCH and the frequency domain candidate position of the PSCCH.

In this embodiment, a PSCCH detection capability of the SL UE is prescribed by a protocol or configured by the gNB, and the gNB configures one of the time domain candidate position or the frequency domain candidate position. The SL UE obtains unconfigured time domain or frequency domain information based on the foregoing information, and then detects the PSCCH.

In some embodiments, when the PSCCH detection capability of the SL UE in a slot is fixed, a quantity of time domain candidate positions of the PSCCH is inversely proportional to a quantity of frequency domain candidate positions of the PSCCH.

In a possible implementation, the method further includes:
the first terminal detects a first sequence, where the first sequence is located before the candidate position of the PSCCH in the mini-slot; in this way, the first terminal can know where to start the detection of the PSCCH by detecting the first sequence, which is equivalent to detecting the starting position of the SL transmission in the mini-slot by performing sequence detection. In this embodiment, a specific sequence is sent before each PSCCH or PSSCH, and the specific sequence may occupy one or half symbol.

It should be noted that the starting positions of the PSCCH and the PSSCH are generally the same. The PSCCH occupies only a part in frequency domain.

The first sequence meets one or more of the following:
(1) in a case that the SL transmission in the mini-slot includes an AGC symbol, the first sequence occupies a first half of the AGC symbol, or the first sequence occupies a second half of the AGC symbol;
(2) in a case that the SL transmission in the mini-slot includes no AGC symbol, one symbol is reserved to transmit the first sequence, or the first sequence is transmitted in a previous gap symbol;
(3) the first sequence uses a preconfigured initial value or root sequence;
(4) the first sequence uses an initial value or a root sequence predefined by a protocol;
(5) the initial value of the first sequence is associated with an identifier (ID) of an SL primary synchronization signal (PSS);
(6) the initial value of the first sequence is associated with an ID of an SL secondary synchronization signal (SSS); and
(7) the initial value of the first sequence is associated with a cyclic redundancy check (CRC) of a physical sidelink broadcast channel (PSBCH).

Based on one or more of the foregoing (1) to (7), the receiving UE can detect the sequence as soon as possible to determine whether there is a PSCCH transmission.

In some embodiments, the first sequence includes one or more of an m sequence, a Gold sequence, a Zadoff Chu (ZC) sequence, and a low peak-to-average power ratio (low-PAPR) sequence.

In a possible implementation, for setting resource reservation of the SL transmission in the mini-slot, the method further includes any one of the following:
(1) the first terminal skips detecting resource reservation indication information in the candidate position of the PSCCH in the mini-slot;
(2) the first terminal detects resource reservation indication information in a candidate position of the PSCCH in a first mini-slot in the slot, and skips detecting one or more of the resource reservation indication information, SCI, and the PSCCH in candidate positions of the PSCCH in other mini-slots; and
(3) the first terminal detects slot-based resource reservation indication information and/or mini-slot-based resource reservation indication information in a first candidate position of the PSCCH in the slot, and detects mini-slot-based resource reservation indication information in other transmission positions of the PSCCH.

In a possible implementation, the method further includes:
the first terminal sends the PSCCH detection capability of the first terminal to the second terminal, so that the second terminal can reserve appropriate resources for the first terminal based on the PSCCH detection capability of the first terminal.

Referring to FIG. 4, an embodiment of this application provides a transmission method, including:
Step 401: A second terminal sends SL data to a first terminal by using a mini-slot.

A length of the mini-slot is less than one slot, one slot includes one or more starting positions of the mini-slot, and the mini-slot includes a candidate position of a PSCCH.

For example, the first terminal may be a terminal serving as a receive end in SL communication, and the second terminal may be a terminal serving as a transmit end in SL communication.

In this embodiment of this application, by detecting the candidate position of the PSCCH in a mini-slot-based SL transmission, mini-slot-based SL data reception is implemented, and resource utilization in an unlicensed band is improved.

For example, the terminal performs the SL transmission by using the mini-slot, and the mini-slot is a transmission unit with a length less than or equal to 13 symbols (that is, the length of the mini-slot is less than one slot). For example, the length of the mini-slot may be 5 or 7 symbols. The SL transmission may be a PSCCH, a PSSCH, or a physical sidelink feedback channel (PSFCH). One slot may include one or more starting positions of the mini-slot. The starting position and/or length of the mini-slot may be predefined or (pre) configured by a protocol, and each SL transmission in the mini-slot includes a candidate position of a PSCCH, which may also be referred to as a PSCCH transmission opportunity.

In a possible implementation, the candidate position of the PSCCH in the mini-slot meets one or more of the following:
(1) in a case that no PSCCH is transmitted in the candidate position of the PSCCH in the mini-slot, first data is transmitted in the candidate position of the PSCCH in the mini-slot, where the first data is dummy data, real data, or SCI (for example, which may be 2nd SCI);
(2) a time domain symbol length of the candidate position of the PSCCH in the mini-slot is one or two symbols (including an AGC symbol);
(3) a frequency domain bandwidth of the candidate position of the PSCCH in the mini-slot is two times or three times a frequency domain bandwidth of the candidate position of the PSCCH in the slot; and
(4) the candidate position of the PSCCH in the mini-slot is configured on a first subchannel, and the first subchannel meets N mod M=K, where N is a first subchannel number, M is a quantity of mini-slots in the slot, and a value range of K is an integer from 0 to M−1.

In some embodiments, one PSCCH may be allocated resources of a plurality of subchannels.

In a possible implementation, the method further includes:
the second terminal sends a first sequence before the PSCCH or the PSSCH in the mini-slot, that is, the starting position of the SL transmission in the mini-slot is detected by the receive end by performing sequence detection, and a specific sequence is sent before each PSCCH or PSSCH, where the specific sequence may occupy one or half symbol.

The first sequence is located before the PSCCH or the PSSCH in the mini-slot, and the first sequence meets one or more of the following:
(1) in a case that the mini-slot includes an AGC symbol, the first sequence occupies a first half of the AGC symbol, or the first sequence occupies a second half of the AGC symbol;
(2) in a case that the mini-slot includes no AGC symbol, one symbol is reserved to transmit the first sequence, or the first sequence is transmitted in a previous gap symbol;
(3) the first sequence uses a preconfigured initial value or root sequence;
(4) the first sequence uses an initial value or a root sequence predefined by a protocol;
(5) the initial value of the first sequence is associated with an ID of an SL PSS;
(6) the initial value of the first sequence is associated with an ID of an SL SSS; and
(7) the initial value of the first sequence is associated with a CRC of a PSBCH.

In some embodiments, the first sequence includes one or more of an m sequence, a Gold sequence, a ZC sequence, and a low-PAPR sequence.

In a possible implementation, the method further includes one or more of the following:
(1) the second terminal skips sending resource reservation indication information in the candidate position of the PSCCH in the mini-slot, that is, skips sending resource reservation indication information on all mini-slot-based PSCCHs;
(2) the second terminal sends resource reservation indication information in a candidate position of the PSCCH in a first mini-slot in the slot, and skips sending one or more of the resource reservation indication information, SCI, and the PSCCH in candidate positions of the PSCCH in other mini-slots, that is, sends a resource reservation indication on the PSCCH in the first mini-slot in the slot, but in the other mini-slots, skips sending the resource reservation indication on the PSCCH, or skips sending 1st SCI, or skips sending the PSCCH channel; and
(3) the second terminal sends slot-based resource reservation indication information and/or mini-slot-based resource reservation indication information in a first candidate position of the PSCCH in the slot, and sends mini-slot-based resource reservation indication information in other candidate positions of the PSCCH, that is, a first candidate position/symbol for sending the PSCCH in the slot may be used to send a slot-based resource reservation indication and/or a mini-slot-based resource reservation indication, but positions of the PSCCH after the first candidate position can only be used to send a mini-slot-based resource reservation indication.

In a possible implementation, the method further includes:
the slot-based resource reservation indication information is sent in the first candidate position of the PSCCH in the slot, and the mini-slot-based resource reservation indication information is sent in the other candidate positions of the PSCCH; before the second terminal sends data in the reserved mini-slot and/or slot corresponding to the resource reservation indication information, the second terminal performs occupancy detection on the reserved mini-slot and/or slot. For example, the slot-based resource reservation indication information is sent in the first candidate position of the PSCCH in the slot, and corresponding mini-slot-based resource reservation indication information is sent in the other candidate positions of the PSCCH. Assuming that the slot includes mini-slot 1, mini-slot 2, and mini-slot 3, when sending the resource reservation indication information on the PSCCH in mini-slot 1, Tx UE indicates that mini-slot 2 and mini-slot 3 are reserved. In this case, before the Tx UE sends data in mini-slot 2 and mini-slot 3, the Tx UE needs to perform occupancy detection on mini-slot 2 and mini-slot 3. In the slot-based transmission, the Tx UE needs to detect, before performing the transmission in the reserved slot, whether the reserved slot is occupied.

In a possible implementation, that the second terminal performs occupancy detection on the reserved mini-slot and/or slot includes:
(1) the second terminal performs occupancy detection in a first time unit before the reserved mini-slot and/or slot, and in a case that it is detected that the reserved mini-slot and/or slot is occupied, the second terminal performs resource reselection; or
(2) the second terminal performs occupancy detection in a second time unit before the reserved mini-slot and/or slot, and in a case that it is detected that the reserved mini-slot and/or slot is occupied, the second terminal abandons the transmission in the reserved mini-slot and/or slot, where
a duration of the second time unit is shorter than a duration of the first time unit.

In other words, the detection time is at least within a T1 time unit before the reserved resource, and if it is detected that the reserved mini-slot/slot is occupied, the UE performs resource reselection.

The detection time is at least within a T2 time unit before the reserved resource, and if it is detected that the reserved mini-slot/slot is occupied, the UE abandons the transmission in the reserved mini-slot/slot.

T2 may be shorter than T1. The UE does not have enough time to complete resource reselection within the T2 time unit before the reserved resource.

In a possible implementation, the method further includes:
the second terminal receives a PSCCH detection capability that is of the first terminal and that is sent by the first terminal.

In this embodiment of this application, whether the PSCCH or PSSCH in the mini-slot can be demodulated depends on a UE capability. The Tx UE exchanges capability information with Rx UE when sending the PSCCH/PSSCH in the mini-slot.

In a possible implementation, the method further includes:
the second terminal obtains first configuration information, where the first configuration information is used to configure whether to forcibly demodulate the PSCCH in the mini-slot on a first resource, and the first resource includes one or more of a resource pool, a bandwidth part (BWP), a Resource Block (RB) set, and a band, that is, whether it is necessary to forcibly demodulate the PSCCH in the mini-slot may be configured or preconfigured by per pool/per BWP/per RB set/per band.

In a possible implementation, in a case that the PSCCH in the mini-slot is forcibly demodulated on the first resource, that the second terminal performs resource reselection includes:
(1) in a case that a priority of data of a preemptive terminal in the reserved mini-slot and/or slot is higher than or not lower than a priority of the data to be transmitted in the reserved mini-slot and/or slot, the second terminal performs resource reselection;
(2) in a case that a priority of the data to be transmitted in the reserved mini-slot and/or slot is lower than or not higher than a first threshold, the second terminal performs resource reselection; or
(3) in a case that a priority of data of a preemptive terminal in the reserved mini-slot and/or slot is higher than or not lower than a second threshold, the second terminal performs resource reselection.

In other words, if the UE forcibly demodulates the PSCCH in the mini-slot in a pool/BWP/RB set/band, the UE needs to compare priorities when performing a pre-emption check, that is, the priority of the data transmission of the preemptive UE is higher than or not lower than the priority of the data to be transmitted, and/or the priority of the data to be transmitted is lower than or not higher than a preset threshold, and/or the priority of the data transmission of the preemptive UE is higher than or not lower than a preset threshold.

If a behavior of the UE in demodulating the PSCCH in the mini-slot in a pool/BWP/RB set/band is an optional behavior of the UE, there is no need to perform one or more of the foregoing priority comparison behaviors, that is, it is only necessary to determine whether the reserved resource is occupied by other UE.

The technical solutions in the embodiments of this application are hereinafter described with reference to specific application examples.

### Example 1

In each mini-slot, a PSCCH transmission opportunity is configured, as shown in FIG. 5, where a time domain symbol length of a candidate position of a PSCCH (that is, a PSCCH transmission opportunity) is two symbols. FIG. 5 includes two PSCCH transmission opportunities, where one located in a left position in FIG. 5 is called a first PSCCH position, and one located in a right position in FIG. 5 is called a second PSCCH position.

If Tx UE sends SL data to Rx UE by using a mini-slot, that is, an SL transmission is based on the mini-slot, the Tx UE sends a PSCCH in each transmission position of the PSCCH, indicating data information transmitted in the mini-slot. In FIG. 5, the second PSCCH position is shown by a dashed-line box, which means that if the Tx UE has detected that the channel is idle before a starting position of a slot, the UE can perform a slot-based transmission and send the PSCCH in the first PSCCH position. In this case, no PSCCH is sent in the second PSCCH position. Alternatively, the UE performs a multi-mini-slot-based transmission, that is, a PSCCH in a first mini-slot is allocated data transmissions of all mini-slots in the entire slot. In this case, no PSCCH is sent in the second PSCCH position in FIG. 5 either. For example, in a case that no PSCCH is transmitted in a candidate position of the PSCCH in the mini-slot, first data is transmitted in the candidate position of the PSCCH in the mini-slot, where the first data is dummy data, real data, or SCI, and may be filled, for example, by a PSSCH or some dummy data.

The Rx UE detects a first sequence, where the first sequence is located before the candidate position of the PSCCH in the mini-slot. For example, the UE detects the PSCCH by detecting a specific sequence. When the UE detects the specific sequence, the UE determines that there is a PSCCH transmission, and performs PSCCH detection. If the UE does not detect a specific sequence, the PSCCH detection is skipped. In a case that the SL transmission in the mini-slot includes an AGC symbol, the first sequence occupies a first half of the AGC symbol, or the first sequence occupies a second half of the AGC symbol. In a case that the SL transmission in the mini-slot includes no AGC symbol, a symbol is reserved to transmit the first sequence, or the first sequence is transmitted in a previous gap symbol. For example, a specific sequence is transmitted on a symbol before the PSCCH, where the symbol may be an AGC symbol in a current mini-slot or a gap symbol in a previous mini-slot/slot.

### Example 2

When there are SL UE performing a slot-based transmission and SL UE performing a mini-slot-based transmission in a system, the SL UE performing the slot-based transmission does not detect a PSCCH in a mini-slot misaligned with a slot edge. Therefore, a resource reservation indication sent by the PSCCH cannot be detected. In addition, mini-slots with different lengths lead to misalignment of PSCCH positions in a slot, and SL UEs performing transmissions based on mini-slots with different lengths may be unable to detect PSCCHs of each other. Therefore, a resource reservation indication in a mini-slot-based transmission can be selected as follows:
1. No resource reservation indication is sent on PSCCHs in all mini-slots, and only resource information of a current transmission is sent on each PSCCH.
2. Tx UE sends resource reservation indication information in a candidate position of a PSCCH in a first mini-slot in the slot, and sends no resource reservation indication information in candidate positions of the PSCCH in other mini-slots. For example, the SL UE performing the mini-slot-based transmission may only send a resource reservation indication on a PSCCH in a mini-slot aligned with the slot edge, and sends no resource reservation indication on other PSCCHs.
3. The Tx UE sends slot-based resource reservation indication information in a first candidate position of the PSCCH in the slot, and sends mini-slot-based resource reservation indication information in other candidate positions of the PSCCH. For example, a subsequent mini-slot-based resource reservation indication may be sent on each mini-slot-based PSCCH. The Tx UE performs occupancy detection on the reserved mini-slot and/or slot. For example, before performing the transmission in the reserved mini-slot, the Tx UE needs to additionally detect whether the resource is occupied. Whether the resource is occupied may be determined by power detection or the like. When detected power exceeds a predetermined threshold, the reserved mini-slot resource is unavailable.

The transmission method provided in the embodiments of this application may be performed by a transmission apparatus. A transmission apparatus provided in the embodiments of this application is described by assuming that the transmission method is performed by the transmission apparatus in the embodiments of this application.

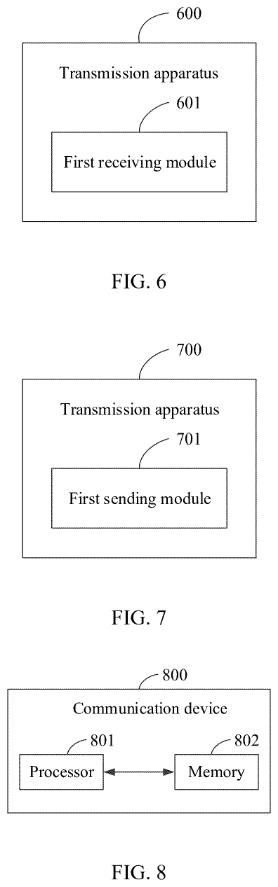

Referring to FIG. 6, an embodiment of this application provides a transmission apparatus 600, including:
a first receiving module 601, configured to receive, by detecting a PSCCH in a candidate position of the PSCCH in a mini-slot, SL data sent by a second terminal, where
a length of the mini-slot is less than one slot, and one slot includes one or more starting positions of the mini-slot.

In a possible implementation, the candidate position of the PSCCH in the mini-slot meets one or more of the following:
in a case that no PSCCH is transmitted in the candidate position of the PSCCH in the mini-slot, first data is transmitted in the candidate position of the PSCCH in the mini-slot, where the first data is dummy data, real data, or SCI;
a time domain symbol length of the candidate position of the PSCCH in the mini-slot is one or two symbols;
a frequency domain bandwidth of the candidate position of the PSCCH in the mini-slot is two times or three times a frequency domain bandwidth of the candidate position of the PSCCH in the slot; and
the candidate position of the PSCCH in the mini-slot is configured on a first subchannel, and the first subchannel meets N mod M=K, where N is a first subchannel number, M is a quantity of mini-slots in the slot, and a value range of K is an integer from 0 to M−1.

In a possible implementation, the apparatus further includes:
a first obtaining module, configured to obtain a time domain candidate position of the PSCCH and a frequency domain candidate position of the PSCCH that are configured by a network side; and
a first detection module, configured to detect the PSCCH based on the time domain candidate position of the PSCCH and the frequency domain candidate position of the PSCCH.

In a possible implementation, the apparatus further includes:
a second obtaining module, configured to obtain a time domain candidate position of the PSCCH;
a first determining module, configured to determine a frequency domain candidate position of the PSCCH based on a PSCCH detection capability of the transmission apparatus and the time domain candidate position of the PSCCH;
a second detection module, configured to detect the PSCCH based on the time domain candidate position of the PSCCH and the frequency domain candidate position of the PSCCH;
a third obtaining module, configured to obtain the frequency domain candidate position of the PSCCH;
a second determining module, configured to determine the time domain candidate position of the PSCCH based on the PSCCH detection capability of the transmission apparatus and the frequency domain candidate position of the PSCCH; and
a third detection module, configured to detect the PSCCH based on the time domain candidate position of the PSCCH and the frequency domain candidate position of the PSCCH.

In a possible implementation, the apparatus further includes:
a fourth detection module, configured to detect a starting position of an SL transmission in the mini-slot by using a first sequence, where
the first sequence is located before the PSCCH or a PSSCH in the mini-slot, and the first sequence meets one or more of the following:
in a case that the SL transmission in the mini-slot includes an AGC symbol, the first sequence occupies a first half of the AGC symbol, or the first sequence occupies a second half of the AGC symbol;
in a case that the SL transmission in the mini-slot includes no AGC symbol, one symbol is reserved to transmit the first sequence, or the first sequence is transmitted in a previous gap symbol;
the first sequence uses a preconfigured initial value or root sequence;
the first sequence uses an initial value or a root sequence predefined by a protocol;
the initial value of the first sequence is associated with an ID of an SL PSS;
the initial value of the first sequence is associated with an ID of an SL SSS; and
the initial value of the first sequence is associated with a CRC of a PSBCH.

In a possible implementation, the first sequence includes one or more of an m sequence, a Gold sequence, a ZC sequence, and a low-PAPR sequence.

In a possible implementation, the apparatus further includes a fifth detection module, configured to perform one or more of the following:
skipping detecting resource reservation indication information in the candidate position of the PSCCH in the mini-slot;
detecting resource reservation indication information in a candidate position of the PSCCH in a first mini-slot in the slot, and skipping detecting one or more of the resource reservation indication information, SCI, and the PSCCH in candidate positions of the PSCCH in other mini-slots; and
detecting slot-based resource reservation indication information and/or mini-slot-based resource reservation indication information in a first candidate position of the PSCCH in the slot, and detecting mini-slot-based resource reservation indication information in other transmission positions of the PSCCH.

In a possible implementation, the apparatus further includes:
a second sending module, configured to send the PSCCH detection capability of the transmission apparatus to the second terminal.

Referring to FIG. 7, an embodiment of this application provides a transmission apparatus 700, including:
a first sending module 701, configured to send SL data to a first terminal by using a mini-slot, where
a length of the mini-slot is less than one slot, one slot includes one or more starting positions of the mini-slot, and the mini-slot includes a candidate position of a PSCCH.

In a possible implementation, the candidate position of the PSCCH in the mini-slot meets one or more of the following:
in a case that no PSCCH is transmitted in the candidate position of the PSCCH in the mini-slot, first data is transmitted in the candidate position of the PSCCH in the mini-slot, where the first data is dummy data, real data, or sidelink control information SCI;
a time domain symbol length of the candidate position of the PSCCH in the mini-slot is two symbols;
a frequency domain bandwidth of the candidate position of the PSCCH in the mini-slot is two times or three times a frequency domain bandwidth of the candidate position of the PSCCH in the slot; and
the candidate position of the PSCCH in the mini-slot is configured on a first subchannel, and the first subchannel meets N mod M=K, where N is a first subchannel number, M is a quantity of mini-slots in the slot, and a value range of K is an integer from 0 to M−1.

In a possible implementation, the apparatus further includes:
a third sending module, configured to send a first sequence before the PSCCH or a PSSCH in the mini-slot, where
the first sequence meets one or more of the following:
in a case that an SL transmission in the mini-slot includes an AGC symbol, the first sequence occupies a first half of the AGC symbol, or the first sequence occupies a second half of the AGC symbol;
in a case that the SL transmission in the mini-slot includes no AGC symbol, one symbol is reserved to transmit the first sequence, or the first sequence is transmitted in a previous gap symbol;
the first sequence uses a preconfigured initial value or root sequence;
the first sequence uses an initial value or a root sequence predefined by a protocol;
the initial value of the first sequence is associated with an identifier ID of an SL PSS;
the initial value of the first sequence is associated with an ID of an SL SSS; and
the initial value of the first sequence is associated with a CRC of a PSBCH.

In a possible implementation, the first sequence includes one or more of an m sequence, a Gold sequence, a ZC sequence, and a low-PAPR sequence.

In a possible implementation, the apparatus further includes a fourth sending module, configured to perform one or more of the following:
skipping sending resource reservation indication information in the candidate position of the PSCCH in the mini-slot;
sending resource reservation indication information in a candidate position of the PSCCH in a first mini-slot in the slot, and skipping sending one or more of the resource reservation indication information, SCI, and the PSCCH in candidate positions of the PSCCH in other mini-slots; and
sending slot-based resource reservation indication information and/or mini-slot-based resource reservation indication information in a first candidate position of the PSCCH in the slot, and sending mini-slot-based resource reservation indication information in other candidate positions of the PSCCH.

In a possible implementation, the apparatus further includes:
a sixth detection module, configured to perform occupancy detection on the reserved mini-slot and/or slot before data is sent in the reserved mini-slot and/or slot corresponding to the resource reservation indication information.

In a possible implementation, the sixth detection module is configured to:
perform occupancy detection in a first time unit before the reserved mini-slot and/or slot, and in a case that it is detected that the reserved mini-slot and/or slot is occupied, perform resource reselection; or
perform occupancy detection in a second time unit before the reserved mini-slot and/or slot, and in a case that it is detected that the reserved mini-slot and/or slot is occupied, abandon the transmission in the reserved mini-slot and/or slot, where
a duration of the second time unit is shorter than a duration of the first time unit.

In a possible implementation, the apparatus further includes:
a second receiving module, configured to receive a PSCCH detection capability that is of the first terminal and that is sent by the first terminal.

In a possible implementation, the apparatus further includes:
a fourth obtaining module, configured to obtain first configuration information, where the first configuration information is used to configure whether to forcibly demodulate the PSCCH in the mini-slot on a first resource, and the first resource includes one or more of a resource pool, a bandwidth part BWP, a resource block set RB set, and a band.

In a possible implementation, in a case that the PSCCH in the mini-slot is forcibly demodulated on the first resource, the sixth detection module is configured to:
in a case that a priority of data of a preemptive terminal in the reserved mini-slot and/or slot is higher than or not lower than a priority of the data to be transmitted in the reserved mini-slot and/or slot, perform resource reselection;
in a case that a priority of the data to be transmitted in the reserved mini-slot and/or slot is lower than or not higher than a first threshold, perform resource reselection; or
in a case that a priority of data of a preemptive terminal in the reserved mini-slot and/or slot is higher than or not lower than a second threshold, perform resource reselection.

The transmission apparatus in this embodiment of this application may be an electronic device, for example, an electronic device with an operating system, or may be a component in an electronic device, for example, an integrated circuit or a chip. The electronic device may be a terminal, or may be other devices than a terminal. For example, the terminal may include but is not limited to the foregoing illustrated type of the terminal 11. The other devices may be a server, a network attached storage (NAS), and the like. This is not specifically limited in this embodiment of this application.

The transmission apparatus provided in this embodiment of this application can implement each process implemented in the method embodiments in FIG. 3 to FIG. 5, with the same technical effect achieved. To avoid repetition, details are not described herein again.

In some embodiments, as shown in FIG. 8, an embodiment of this application further provides a communication device 800, including a processor 801 and a memory 802. The memory 802 stores a program or instructions capable of running on the processor 801. For example, when the communication device 800 is a terminal, and the program or instructions are executed by the processor 801, the steps of the foregoing embodiment of the transmission method are implemented, with the same technical effect achieved. When the communication device 800 is a network-side device, and the program or instructions are executed by the processor 801, the steps of the foregoing embodiment of the transmission method are implemented, with the same technical effect achieved. To avoid repetition, details are not described herein again.

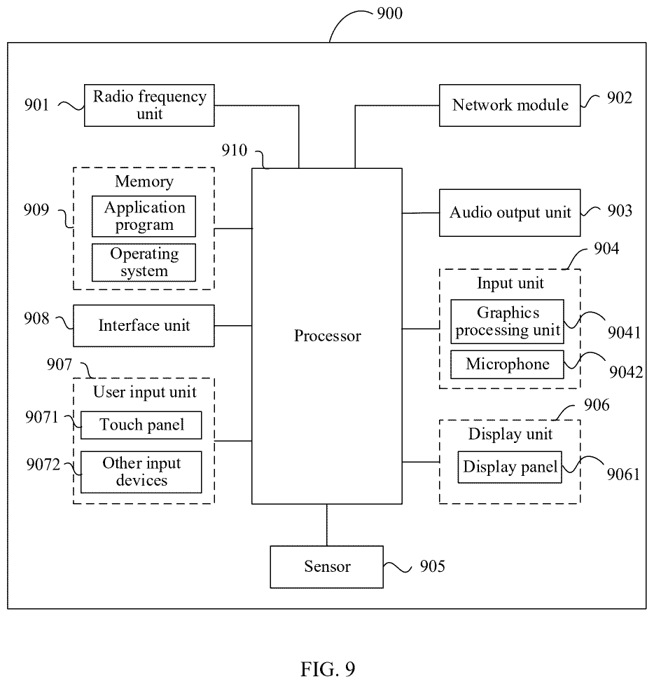

An embodiment of this application further provides a terminal, including a processor and a communication interface. The communication interface is configured to: receive, by a first terminal by detecting a physical sidelink control channel PSCCH in a candidate position of the PSCCH in a mini-slot, SL data sent by a second terminal, where a length of the mini-slot is less than one slot, and one slot includes one or more starting positions of the mini-slot; or send, by a second terminal, SL data to a first terminal by using a mini-slot, where a length of the mini-slot is less than one slot, one slot includes one or more starting positions of the mini-slot, and the mini-slot includes a candidate position of a PSCCH. The terminal embodiment corresponds to the foregoing terminal-side method embodiment, and each implementation process and implementation of the foregoing method embodiment can be applied to the terminal embodiment, with the same technical effect achieved. For example, FIG. 9 is a schematic diagram of a hardware structure of a terminal for implementing an embodiment of this application.

The terminal 900 includes but is not limited to at least some components such as a radio frequency unit 901, a network module 902, an audio output unit 903, an input unit 904, a sensor 905, a display unit 906, a user input unit 907, an interface unit 908, a memory 909, and a processor 910.

A person skilled in the art may understand that the terminal 900 may further include a power supply (for example, a battery) supplying power to all components. The power supply may be logically connected to the processor 910 through a power management system. In this way, functions such as charge management, discharge management, and power consumption management are implemented by using the power management system. The terminal structure shown in FIG. 9 does not constitute a limitation on the terminal. The terminal may include more or fewer components than those shown in the figure, or some components are combined, or component arrangements are different. Details are not described herein again.

It should be understood that, in this embodiment of this application, the input unit 904 may include a Graphics Processing Unit (GPU) 9041 and a microphone 9042. The graphics processing unit 9041 processes image data of a still picture or video obtained by an image capture apparatus (such as a camera) in a video capture mode or an image capture mode. The display unit 906 may include a display panel 9061, and the display panel 9061 may be configured in a form of a liquid crystal display, an organic light-emitting diode, or the like. The user input unit 907 includes at least one of a touch panel 9071 and other input devices 9072. The touch panel 9071 is also referred to as a touchscreen. The touch panel 9071 may include two parts: a touch detection apparatus and a touch controller. The other input devices 9072 may include but are not limited to a physical keyboard, a function button (such as a volume control button or a power button), a trackball, a mouse, and a joystick. Details are not described herein again.

In this embodiment of this application, after receiving downlink data from a network-side device, the radio frequency unit 901 may transmit the downlink data to the processor 910 for processing. In addition, the radio frequency unit 901 may send uplink data to the network-side device. Usually, the radio frequency unit 901 includes but is not limited to an antenna, an amplifier, a transceiver, a coupler, a low noise amplifier, a duplexer, and the like.

The memory 909 may be configured to store software programs or instructions and various data. The memory 909 may primarily include a first storage area for storing programs or instructions and a second storage area for storing data. The first storage area may store an operating system, an application program or instructions required by at least one function (such as an audio play function and an image play function), and the like. In addition, the memory 909 may include a volatile memory or a non-volatile memory, or the memory 909 may include both a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDR SDRAM), an Enhanced SDRAM (ESDRAM), a Synch Link DRAM (SLDRAM), and a Direct Rambus RAM (DRRAM). The memory 909 in this embodiment of this application includes but is not limited to these and any other suitable types of memories.

The processor 910 may include one or more processing units. In some embodiments, the processor 910 integrates an application processor and a modem processor. The application processor mainly processes operations related to the operating system, a user interface, an application program, and the like. The modem processor mainly processes a wireless communication signal. For example, the modem processor is a baseband processor. For example, it may be understood that the modem processor may be not integrated in the processor 910.

In a case that the terminal 900 is used as a receiving terminal, that is, the first terminal in the method description:
the processor 910 is configured to receive, by detecting a PSCCH in a candidate position of the PSCCH in a mini-slot, SL data sent by a second terminal, where
a length of the mini-slot is less than one slot, and one slot includes one or more starting positions of the mini-slot.

In some embodiments, the candidate position of the PSCCH in the mini-slot meets one or more of the following:
in a case that no PSCCH is transmitted in the candidate position of the PSCCH in the mini-slot, first data is transmitted in the candidate position of the PSCCH in the mini-slot, where the first data is dummy data, real data, or SCI;
a time domain symbol length of the candidate position of the PSCCH in the mini-slot is one or two symbols;
a frequency domain bandwidth of the candidate position of the PSCCH in the mini-slot is two times or three times a frequency domain bandwidth of the candidate position of the PSCCH in the slot; and
the candidate position of the PSCCH in the mini-slot is configured on a first subchannel, and the first subchannel meets N mod M=K, where N is a first subchannel number, M is a quantity of mini-slots in the slot, and a value range of K is an integer from 0 to M−1.

In some embodiments, the processor 910 is configured to obtain a time domain candidate position of the PSCCH and a frequency domain candidate position of the PSCCH that are configured by a network side; and
the processor 910 is configured to detect the PSCCH based on the time domain candidate position of the PSCCH and the frequency domain candidate position of the PSCCH.

In some embodiments, the processor 910 is configured to obtain a time domain candidate position of the PSCCH;
the processor 910 is configured to determine a frequency domain candidate position of the PSCCH based on a PSCCH detection capability of the transmission apparatus and the time domain candidate position of the PSCCH;
the processor 910 is configured to detect the PSCCH based on the time domain candidate position of the PSCCH and the frequency domain candidate position of the PSCCH;
the processor 910 is configured to obtain the frequency domain candidate position of the PSCCH;
the processor 910 is configured to determine the time domain candidate position of the PSCCH based on the PSCCH detection capability of the transmission apparatus and the frequency domain candidate position of the PSCCH; and
the processor 910 is configured to detect the PSCCH based on the time domain candidate position of the PSCCH and the frequency domain candidate position of the PSCCH.

In some embodiments, the processor 910 is configured to detect a starting position of an SL transmission in the mini-slot by using a first sequence, where
the first sequence is located before the PSCCH or a PSSCH in the mini-slot, and the first sequence meets one or more of the following:
in a case that an SL transmission in the mini-slot includes an AGC symbol, the first sequence occupies a first half of the AGC symbol, or the first sequence occupies a second half of the AGC symbol;
in a case that the SL transmission in the mini-slot includes no AGC symbol, one symbol is reserved to transmit the first sequence, or the first sequence is transmitted in a previous gap symbol;
the first sequence uses a preconfigured initial value or root sequence;
the first sequence uses an initial value or a root sequence predefined by a protocol;
the initial value of the first sequence is associated with an ID of an SL PSS;
the initial value of the first sequence is associated with an ID of an SL SSS; and
the initial value of the first sequence is associated with a CRC of a PSBCH.

In some embodiments, the first sequence includes one or more of an m sequence, a Gold sequence, a ZC sequence, and a low-PAPR sequence.

In some embodiments, the processor 910 is configured to perform one or more of the following:
skipping detecting resource reservation indication information in the candidate position of the PSCCH in the mini-slot;
detecting resource reservation indication information in a candidate position of the PSCCH in a first mini-slot in the slot, and skipping detecting one or more of the resource reservation indication information, SCI, and the PSCCH in candidate positions of the PSCCH in other mini-slots; and
detecting slot-based resource reservation indication information and/or mini-slot-based resource reservation indication information in a first candidate position of the PSCCH in the slot, and detecting mini-slot-based resource reservation indication information in other transmission positions of the PSCCH.

In some embodiments, the processor 910 is configured to send the PSCCH detection capability of the transmission apparatus to the second terminal.

In a case that the terminal 900 is used as a sending terminal, that is, the second terminal in the method description:
the processor 910 is configured to send SL data to a first terminal by using a mini-slot, where
a length of the mini-slot is less than one slot, one slot includes one or more starting positions of the mini-slot, and the mini-slot includes a candidate position of a PSCCH.

In some embodiments, the candidate position of the PSCCH in the mini-slot meets one or more of the following:
in a case that no PSCCH is transmitted in the candidate position of the PSCCH in the mini-slot, first data is transmitted in the candidate position of the PSCCH in the mini-slot, where the first data is dummy data, real data, or sidelink control information SCI;
a time domain symbol length of the candidate position of the PSCCH in the mini-slot is two symbols;
a frequency domain bandwidth of the candidate position of the PSCCH in the mini-slot is two times or three times a frequency domain bandwidth of the candidate position of the PSCCH in the slot; and
the candidate position of the PSCCH in the mini-slot is configured on a first subchannel, and the first subchannel meets N mod M=K, where N is a first subchannel number, M is a quantity of mini-slots in the slot, and a value range of K is an integer from 0 to M−1.

In some embodiments, the processor 910 is configured to send a first sequence before the PSCCH or a PSSCH in the mini-slot, where
the first sequence meets one or more of the following:
in a case that an SL transmission in the mini-slot includes an AGC symbol, the first sequence occupies a first half of the AGC symbol, or the first sequence occupies a second half of the AGC symbol;
in a case that the SL transmission in the mini-slot includes no AGC symbol, one symbol is reserved to transmit the first sequence, or the first sequence is transmitted in a previous gap symbol;
the first sequence uses a preconfigured initial value or root sequence;
the first sequence uses an initial value or a root sequence predefined by a protocol;
the initial value of the first sequence is associated with an identifier ID of an SL PSS;
the initial value of the first sequence is associated with an ID of an SL SSS; and
the initial value of the first sequence is associated with a CRC of a PSBCH.

In some embodiments, the first sequence includes one or more of an m sequence, a Gold sequence, a ZC sequence, and a low-PAPR sequence.

In some embodiments, the processor 910 is configured to perform one or more of the following:
skipping sending resource reservation indication information in the candidate position of the PSCCH in the mini-slot;
sending resource reservation indication information in a candidate position of the PSCCH in a first mini-slot in the slot, and skipping sending one or more of the resource reservation indication information, SCI, and the PSCCH in candidate positions of the PSCCH in other mini-slots; and
sending slot-based resource reservation indication information and/or mini-slot-based resource reservation indication information in a first candidate position of the PSCCH in the slot, and sending mini-slot-based resource reservation indication information in other candidate positions of the PSCCH.

In some embodiments, the processor 910 is configured to perform occupancy detection on the reserved mini-slot and/or slot before data is sent in the reserved mini-slot and/or slot corresponding to the resource reservation indication information.

In some embodiments, the processor 910 is configured to:
perform occupancy detection in a first time unit before the reserved mini-slot and/or slot, and in a case that it is detected that the reserved mini-slot and/or slot is occupied, perform resource reselection; or
perform occupancy detection in a second time unit before the reserved mini-slot and/or slot, and in a case that it is detected that the reserved mini-slot and/or slot is occupied, abandon the transmission in the reserved mini-slot and/or slot, where
a duration of the second time unit is shorter than a duration of the first time unit.

In some embodiments, the processor 910 is configured to receive a PSCCH detection capability that is of the first terminal and that is sent by the first terminal.

In some embodiments, the processor 910 is configured to obtain first configuration information, where the first configuration information is used to configure whether to forcibly demodulate the PSCCH in the mini-slot on a first resource, and the first resource includes one or more of a resource pool, a bandwidth part BWP, a resource block set RB set, and a band.

In some embodiments, in a case that the PSCCH in the mini-slot is forcibly demodulated on the first resource, the processor 910 is configured to:
in a case that a priority of data of a preemptive terminal in the reserved mini-slot and/or slot is higher than or not lower than a priority of the data to be transmitted in the reserved mini-slot and/or slot, perform resource reselection;
in a case that a priority of the data to be transmitted in the reserved mini-slot and/or slot is lower than or not higher than a first threshold, perform resource reselection; or
in a case that a priority of data of a preemptive terminal in the reserved mini-slot and/or slot is higher than or not lower than a second threshold, perform resource reselection.

An embodiment of this application further provides a readable storage medium. The readable storage medium has stored thereon a program or instructions. When the program or instructions are executed by a processor, each process of the foregoing embodiment of the transmission method is implemented, with the same technical effect achieved. To avoid repetition, details are not described herein again.

The processor is a processor in the terminal in the foregoing embodiment. The readable storage medium includes a computer-readable storage medium, such as a computer read-only memory ROM, a random access memory RAM, a magnetic disk, or an optical disc.

In addition, an embodiment of this application provides a chip. The chip includes a processor and a communication interface. The communication interface is coupled to the processor. The processor is configured to run a program or instructions to implement each process of the foregoing embodiment of the transmission method, with the same technical effect achieved. To avoid repetition, details are not described herein again.

It should be understood that the chip provided in this embodiment of this application may also be referred to as a system-level chip, a system chip, a chip system, a system-on-chip, or the like.

In addition, an embodiment of this application provides a computer program or program product. The computer program or program product is stored in a storage medium. The computer program or program product is executed by at least one processor to implement each process of the foregoing embodiment of the transmission method, with the same technical effect achieved. To avoid repetition, details are not described herein again.

It should be noted that in this specification, the term “comprise”, “include”, or any of their variants are intended to cover a non-exclusive inclusion, so that a process, a method, an article, or an apparatus that includes a list of elements not only includes those elements but also includes other elements that are not expressly listed, or further includes elements inherent to such process, method, article, or apparatus. In absence of more constraints, an element preceded by “includes a . . . ” does not preclude existence of other identical elements in the process, method, article, or apparatus that includes the element. In addition, it should be noted that the scope of the method and apparatus in the implementations of this application is not limited to performing the functions in an order shown or discussed, and may further include performing the functions in a substantially simultaneous manner or in a reverse order depending on the functions used. For example, the method described may be performed in an order different from that described, and various steps may be added, omitted, or combined. In addition, features described with reference to some examples may be combined in other examples.

According to the foregoing description of the implementations, a person skilled in the art may clearly understand that the methods in the foregoing embodiments may be implemented by using software in combination with a necessary general hardware platform, and may alternatively be implemented by using hardware. However, in most cases, the former is an example implementation. Based on such an understanding, the technical solutions of this application essentially or the part contributing to the prior art may be implemented in a form of a computer software product. The computer software product is stored in a storage medium (such as a ROM/RAM, a magnetic disk, or an optical disc), and includes several instructions for instructing a terminal (which may be a mobile phone, a computer, a server, an air conditioner, a network device, or the like) to perform the methods described in the embodiments of this application.

The foregoing describes the embodiments of this application with reference to the accompanying drawings. However, this application is not limited to the foregoing specific embodiments. The foregoing specific embodiments are merely illustrative rather than restrictive. Inspired by this application, a person of ordinary skill in the art may develop many other manners without departing from principles of this application and the protection scope of the claims, and all such manners fall within the protection scope of this application.

What is claimed is:

1. A transmission method, comprising:
receiving, by a first terminal by detecting a physical sidelink control channel (PSCCH) in a candidate position of the PSCCH in a mini-slot, sidelink (SL) data sent by a second terminal, wherein
a length of the mini-slot is less than one slot, and one slot comprises one or more starting positions of the mini-slot.

2. The method according to claim 1, wherein the candidate position of the PSCCH in the mini-slot meets one or more of the following:
when no PSCCH is transmitted in the candidate position of the PSCCH in the mini-slot, first data is transmitted in the candidate position of the PSCCH in the mini-slot, wherein the first data is dummy data, real data, or sidelink control information (SCI);
a time domain symbol length of the candidate position of the PSCCH in the mini-slot is one or two symbols;
a frequency domain bandwidth of the candidate position of the PSCCH in the mini-slot is two times or three times a frequency domain bandwidth of the candidate position of the PSCCH in the slot; or
the candidate position of the PSCCH in the mini-slot is configured on a first subchannel, and the first subchannel meets N mod M=K, wherein N is a first subchannel number, M is a quantity of mini-slots in the slot, and a value range of K is an integer from 0 to M−1.

3. The method according to claim 1, further comprising:
obtaining, by the first terminal, a time domain candidate position of the PSCCH and a frequency domain candidate position of the PSCCH that are configured by a network side; and
detecting, by the first terminal, the PSCCH based on the time domain candidate position of the PSCCH and the frequency domain candidate position of the PSCCH.

4. The method according to claim 1, further comprising:
obtaining, by the first terminal, a time domain candidate position of the PSCCH;
determining, by the first terminal, a frequency domain candidate position of the PSCCH based on a PSCCH detection capability of the first terminal and the time domain candidate position of the PSCCH; and
detecting, by the first terminal, the PSCCH based on the time domain candidate position of the PSCCH and the frequency domain candidate position of the PSCCH, or
obtaining, by the first terminal, a frequency domain candidate position of the PSCCH;
determining, by the first terminal, a time domain candidate position of the PSCCH based on a PSCCH detection capability of the first terminal and the frequency domain candidate position of the PSCCH; and
detecting, by the first terminal, the PSCCH based on the time domain candidate position of the PSCCH and the frequency domain candidate position of the PSCCH.

5. The method according to claim 1, further comprising:
detecting, by the first terminal, a first sequence, wherein the first sequence is located before the candidate position of the PSCCH in the mini-slot, and the first sequence meets one or more of the following:
when the mini-slot comprises an automatic gain control (AGC) symbol, the first sequence occupies a first half of the AGC symbol, or the first sequence occupies a second half of the AGC symbol;
when the mini-slot comprises no AGC symbol, one symbol is reserved to transmit the first sequence, or the first sequence is transmitted in a previous gap symbol;
the first sequence uses a preconfigured initial value or root sequence;
the first sequence uses an initial value or a root sequence predefined by a protocol;
the initial value of the first sequence is associated with an identifier (ID) of an SL primary synchronization signal (PSS);
the initial value of the first sequence is associated with an ID of an SL secondary synchronization signal (SSS); or
the initial value of the first sequence is associated with a cyclic redundancy check (CRC) of a physical sidelink broadcast channel (PSBCH).

6. The method according to claim 5, wherein the first sequence comprises one or more of an m sequence, a Gold sequence, a Zadoff Chu (ZC) sequence, or a low peak-to-average power ratio (low-PAPR) sequence.

7. The method according to claim 1, further comprising any one of the following:
skipping detecting, by the first terminal, resource reservation indication information in the candidate position of the PSCCH in the mini-slot;
detecting, by the first terminal, resource reservation indication information in a candidate position of the PSCCH in a first mini-slot in the slot, and skipping detecting one or more of the resource reservation indication information, SCI, or the PSCCH in candidate positions of the PSCCH in other mini-slots; or
detecting, by the first terminal, slot-based resource reservation indication information or mini-slot-based resource reservation indication information in a first candidate position of the PSCCH in the slot, and detecting mini-slot-based resource reservation indication information in other transmission positions of the PSCCH.

8. A transmission method, comprising:
sending, by a second terminal, sidelink (SL) data to a first terminal by using a mini-slot, wherein
a length of the mini-slot is less than one slot, one slot comprises one or more starting positions of the mini-slot, the mini-slot comprises a candidate position of a physical sidelink control channel (PSCCH), and the candidate position of the PSCCH is used to transmit the PSCCH.

9. The method according to claim 8, wherein the candidate position of the PSCCH in the mini-slot meets one or more of the following:
when no PSCCH is transmitted in the candidate position of the PSCCH in the mini-slot, first data is transmitted in the candidate position of the PSCCH in the mini-slot, wherein the first data is dummy data, real data, or sidelink control information (SCI);
a time domain symbol length of the candidate position of the PSCCH in the mini-slot is two symbols;
a frequency domain bandwidth of the candidate position of the PSCCH in the mini-slot is two times or three times a frequency domain bandwidth of the candidate position of the PSCCH in the slot; or
the candidate position of the PSCCH in the mini-slot is configured on a first subchannel, and the first subchannel meets N mod M=K, wherein N is a first subchannel number, M is a quantity of mini-slots in the slot, and a value range of K is an integer from 0 to M−1.

10. The method according to claim 8, further comprising:
sending, by the second terminal, a first sequence before the candidate position of the PSCCH in the mini-slot, wherein
the first sequence meets one or more of the following:
when the mini-slot comprises an automatic gain control (AGC) symbol, the first sequence occupies a first half of the AGC symbol, or the first sequence occupies a second half of the AGC symbol;
when the mini-slot comprises no AGC symbol, one symbol is reserved to transmit the first sequence, or the first sequence is transmitted in a previous gap symbol;
the first sequence uses a preconfigured initial value or root sequence;
the first sequence uses an initial value or a root sequence predefined by a protocol;
the initial value of the first sequence is associated with an identifier (ID) of an SL primary synchronization signal (PSS);
the initial value of the first sequence is associated with an ID of an SL secondary synchronization signal (SSS); or
the initial value of the first sequence is associated with a cyclic redundancy check (CRC) of a physical sidelink broadcast channel (PSBCH).

11. The method according to claim 10, wherein the first sequence comprises one or more of an m sequence, a Gold sequence, a Zadoff Chu (ZC) sequence, or a low peak-to-average power ratio (low-PAPR) sequence.

12. The method according to claim 8, further comprising one or more of the following:
skipping sending, by the second terminal, resource reservation indication information in the candidate position of the PSCCH in the mini-slot;
sending, by the second terminal, resource reservation indication information in a candidate position of the PSCCH in a first mini-slot in the slot, and skipping sending one or more of the resource reservation indication information, SCI, or the PSCCH in candidate positions of the PSCCH in other mini-slots; or
sending, by the second terminal, slot-based resource reservation indication information or mini-slot-based resource reservation indication information in a first candidate position of the PSCCH in the slot, and sending mini-slot-based resource reservation indication information in other candidate positions of the PSCCH.

13. The method according to claim 12, further comprising:
before the second terminal sends data in the reserved mini-slot or slot corresponding to the resource reservation indication information, performing, by the second terminal, occupancy detection on the reserved mini-slot or slot.

14. The method according to claim 13, wherein the performing, by the second terminal, the occupancy detection on the reserved mini-slot or slot comprises:
performing, by the second terminal, occupancy detection in a first time unit before the reserved mini-slot or slot, and when it is detected that the reserved mini-slot or slot is occupied, performing, by the second terminal, resource reselection; or
performing, by the second terminal, occupancy detection in a second time unit before the reserved mini-slot or slot, and when it is detected that the reserved mini-slot or slot is occupied, abandoning, by the second terminal, the transmission in the reserved mini-slot or slot, wherein a duration of the second time unit is shorter than a duration of the first time unit.

15. The method according to claim 9, further comprising:
obtaining, by the second terminal, first configuration information, wherein the first configuration information is used to configure whether to forcibly demodulate the PSCCH in the mini-slot on a first resource, and the first resource comprises one or more of a resource pool, a bandwidth part (BWP), a resource block (RB) set, or a band.

16. The method according to claim 15, wherein when the PSCCH in the mini-slot is forcibly demodulated on the first resource, performing, by the second terminal, resource reselection comprises:
when a priority of data of a preemptive terminal in the reserved mini-slot or slot is higher than or not lower than a priority of the data to be transmitted in the reserved mini-slot or slot, performing, by the second terminal, resource reselection;
when a priority of the data to be transmitted in the reserved mini-slot or slot is lower than or not higher than a first threshold, performing, by the second terminal, resource reselection; or
when a priority of data of a preemptive terminal in the reserved mini-slot or slot is higher than or not lower than a second threshold, performing, by the second terminal, resource reselection.

17. A terminal, comprising a processor and a memory storing instructions, wherein the instructions, when executed by the processor, cause the processor to perform operations comprising:
receiving sidelink (SL) data sent by a second terminal by detecting a physical sidelink control channel (PSCCH) in a candidate position of the PSCCH in a mini-slot, wherein
a length of the mini-slot is less than one slot, and one slot comprises one or more starting positions of the mini-slot.

18. The terminal according to claim 17, wherein the candidate position of the PSCCH in the mini-slot meets one or more of the following:
when no PSCCH is transmitted in the candidate position of the PSCCH in the mini-slot, first data is transmitted in the candidate position of the PSCCH in the mini-slot, wherein the first data is dummy data, real data, or sidelink control information (SCI);
a time domain symbol length of the candidate position of the PSCCH in the mini-slot is one or two symbols;
a frequency domain bandwidth of the candidate position of the PSCCH in the mini-slot is two times or three times a frequency domain bandwidth of the candidate position of the PSCCH in the slot; or
the candidate position of the PSCCH in the mini-slot is configured on a first subchannel, and the first subchannel meets N mod M=K, wherein N is a first subchannel number, M is a quantity of mini-slots in the slot, and a value range of K is an integer from 0 to M−1.

19. The terminal according to claim 17, wherein the instructions, when executed by the processor, cause the processor to further perform operations comprising:
obtaining a time domain candidate position of the PSCCH and a frequency domain candidate position of the PSCCH that are configured by a network side; and
detecting the PSCCH based on the time domain candidate position of the PSCCH and the frequency domain candidate position of the PSCCH.

20. The terminal according to claim 17, wherein the instructions, when executed by the processor, cause the processor to further perform operations comprising:
obtaining, by the first terminal, a time domain candidate position of the PSCCH;
determining, by the first terminal, a frequency domain candidate position of the PSCCH based on a PSCCH detection capability of the first terminal and the time domain candidate position of the PSCCH; and
detecting, by the first terminal, the PSCCH based on the time domain candidate position of the PSCCH and the frequency domain candidate position of the PSCCH, or
obtaining, by the first terminal, a frequency domain candidate position of the PSCCH;
determining, by the first terminal, a time domain candidate position of the PSCCH based on a PSCCH detection capability of the first terminal and the frequency domain candidate position of the PSCCH; and
detecting, by the first terminal, the PSCCH based on the time domain candidate position of the PSCCH and the frequency domain candidate position of the PSCCH.
